(19) United States
(12) Patent Application Publication
(10) Pub. No.: US 2024/0338045 A1
(43) Pub. Date: Oct. 10, 2024

(54) CURRENT GENERATION CIRCUIT

(71) Applicant: ROHM CO., LTD., Kyoto-shi (JP)

(72) Inventor: Naohiro NOMURA, Kyoto (JP)

(21) Appl. No.: 18/750,126

(22) Filed: Jun. 21, 2024

Related U.S. Application Data
(63) Continuation of application No. PCT/JP2022/046487, filed on Dec. 16, 2022.

(30) Foreign Application Priority Data
Dec. 24, 2021 (JP) 2021-210827

(51) Int. Cl. G05F 3/26

(52) U.S. Cl. CPC G05F 3/26

(57) ABSTRACT

The current generation circuit includes a plurality of current cells and a combining circuit. A temperature-dependent current generated by each of the current cells is zero in a temperature range intrinsic to the current cell, and linearly changes with respect to a temperature outside the temperature range. The combining circuit combines the plurality of temperature-dependent currents generated by the plurality of current cells and outputs a correction current.

### CROSS REFERENCE TO RELATED APPLICATIONS

This application is a continuation under 35 U.S.C. § 120 of PCT/JP2022/046487, filed Dec. 16, 2022, which is incorporated herein by reference, and which claimed priority to Japanese Application No. 2021-210827, filed Dec. 24, 2021. The present application likewise claims priority under 35 U.S.C. § 119 to Japanese Application No. 2021-210827, filed Dec. 24, 2021, the entire content of which is also incorporated herein by reference.

### BACKGROUND

### 1. Technical Field

The present disclosure relates to a current generation circuit in a semiconductor integrated circuit.

### 2. Related Art

In a semiconductor integrated circuit, a constant voltage and a constant current without temperature dependency are required. In order to generate a constant voltage without temperature dependency, a bandgap reference circuit is widely used.

The bandgap reference circuit can achieve an almost completely flat temperature characteristic in a certain temperature range by primary and secondary temperature compensation. Specifically, in the case of the bandgap reference circuit, a flat temperature characteristic can be achieved in a temperature range of, for example, 30 to 110° C.

However, in a case of use in a temperature range of −40° C. to 140° C., a voltage varies by about 5 to 6 mV. If there is a current generation circuit capable of generating an electric current having a flexible temperature characteristic in a wide temperature range, the temperature characteristic of the bandgap reference circuit can be made flatter by using the current generation circuit as a temperature characteristic correction circuit.

### BRIEF DESCRIPTION OF DRAWINGS

Embodiments will now be described, by way of example only, with reference to the accompanying drawings which are meant to be exemplary, not limiting, and wherein like elements are numbered alike in several Figures, in which:

FIG. 1 is a block diagram of a semiconductor integrated circuit according to an embodiment;

FIG. 2 is a block diagram of a current generation circuit;

FIG. 3 is a diagram for describing an example of an operation of the current generation circuit;

FIG. 4 is a diagram for describing another example of the operation of the current generation circuit;

FIG. 5 is a diagram for describing an example of the operation of the current generation circuit;

FIG. 6 is a circuit diagram illustrating a configuration example of a low-temperature correction cell;

FIG. 7 is a diagram for describing an operation of the low-temperature correction cell of FIG. 6;

FIG. 8 is a circuit diagram illustrating a configuration example of a high-temperature correction cell;

FIG. 9 is a diagram for describing an operation of the high-temperature correction cell of FIG. 8;

FIG. 10 is a circuit diagram of a combining circuit according to one example;

FIG. 11 is a circuit diagram of a combining circuit according to one example;

FIG. 12 is a circuit diagram illustrating a semiconductor integrated circuit according to one example;

FIG. 13 is a diagram illustrating a temperature characteristic of an output voltage V_{BGR} of the bandgap reference circuit of FIG. 12;

FIG. 14 is a circuit diagram of a current generation circuit according to Modification 1;

FIG. 15 is a diagram for describing an operation of the current generation circuit of FIG. 14; and

FIG. 16 is a diagram for describing a setting example of a combining circuit in the current generation circuit of FIG. 14.

### DETAILED DESCRIPTION

### Outline of Embodiment

An outline of several example embodiments of the disclosure follows. This outline is provided for the convenience of the reader to provide a basic understanding of such embodiments and does not wholly define the breadth of the disclosure. This outline is not an extensive overview of all contemplated embodiments and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “one embodiment” may be used herein to refer to a single embodiment or multiple embodiments of the disclosure.

A current generation circuit according to one embodiment of the present disclosure includes a plurality of current cells and a combining circuit that combines a plurality of temperature-dependent currents generated by the plurality of current cells. A temperature-dependent current generated by each of the current cells is zero in a temperature range intrinsic to the current cell, and linearly changes with respect to a temperature outside the temperature range.

According to this current generation circuit, it is possible to generate a current that is zero or a constant amount in a temperature range in which conventional temperature compensation is performed and has temperature dependency in a low temperature region or a high temperature region in which conventional temperature compensation is performed insufficiently. By using this current generation circuit as a temperature characteristic correction circuit, temperature dependency of a target can be compensated.

In one embodiment, the plurality of current cells may include at least one low-temperature correction cell. The low-temperature correction cell may generate a low-temperature correction current that is zero in a temperature range above its intrinsic threshold and has a negative temperature coefficient in a temperature range below the threshold.

In one embodiment, the low-temperature correction cell may generate the low-temperature correction current by subtracting a current having a positive temperature coefficient from a current having a negative temperature coefficient.

In one embodiment, the low-temperature correction cell may include a first current mirror circuit, a second current mirror circuit that folds a current having a negative temperature coefficient and supplies the current to an input of the first current mirror circuit, and a third current mirror circuit that folds a current having a positive temperature coefficient and draws the current from the input of the first current mirror circuit to another path.

In one embodiment, the plurality of current cells may include at least one high-temperature correction cell. The high-temperature correction cell may generate a high-temperature correction current that is zero in a temperature range below its intrinsic threshold and has a positive temperature coefficient in a temperature range above the threshold.

In one embodiment, the high-temperature correction cell may generate the high-temperature correction current by subtracting a current having a negative temperature coefficient from a current having a positive temperature coefficient.

In one embodiment, the high-temperature correction cell may include a fourth current mirror circuit, a fifth current mirror circuit that folds a current having a positive temperature coefficient and supplies the current to an input of the fourth current mirror circuit, and a sixth current mirror circuit that folds a current having a negative temperature coefficient and draws the current from the input of the fourth current mirror circuit to another path.

In one embodiment, the combining circuit may have a variable ratio among a plurality of currents.

In one embodiment, the current generation circuit may further include a constant current cell that generates a constant current not dependent on temperature. The combining circuit may combine the plurality of temperature-dependent currents and the constant current.

In one embodiment, the constant current cell may generate the constant current by adding a current having a positive temperature coefficient and a current having a negative temperature coefficient.

In one embodiment, the current generation circuit may be integrally integrated on one semiconductor substrate. The term “integrally integrated” includes a case where all components of the circuit are formed on the semiconductor substrate and a case where main components of the circuit are integrally integrated, and some resistors, capacitors, and the like may be disposed outside the semiconductor substrate for adjusting a circuit constant. By integrating the circuit on one chip, a circuit area can be reduced, and a characteristic of a circuit element can be kept uniform.

A semiconductor integrated circuit according to one embodiment may include a bandgap reference circuit and the current generation circuit according to any one of the above-described circuits, to be coupled to the bandgap reference circuit.

### Embodiment

Hereinafter, a preferred embodiment will be described with reference to the drawings. The same or equivalent components, members, and treatments illustrated in the drawings are denoted by the same reference numerals, and duplicative description will be omitted appropriately. In addition, the embodiments do not limit the disclosure and the invention and are described for illustrative purposes, and all the features described in the embodiments and a combination thereof are not necessarily essential to the disclosure and the invention.

In the present specification, “a state in which a member A is coupled to a member B” includes a case where the member A and the member B are coupled to each other in a physically direct manner, and a case where the member A and the member B are indirectly coupled to each other via another member that does not substantially affect an electrical coupling state between the members A and B or does not impair a function or an effect exhibited by the coupling between the members A and B.

Similarly, “a state in which a member C is disposed between a member A and a member B” includes not only a case where the member A and the member C, or the member B and the member C are directly coupled to each other, but also a case where the member A and the member C, or the member B and the member C are indirectly coupled to each other via another member that does not substantially affect an electrical coupling state between the member A and the member C or between the member B and the member C or does not impair a function or an effect exhibited by the coupling between the member A and the member C or between the member B and the member C.

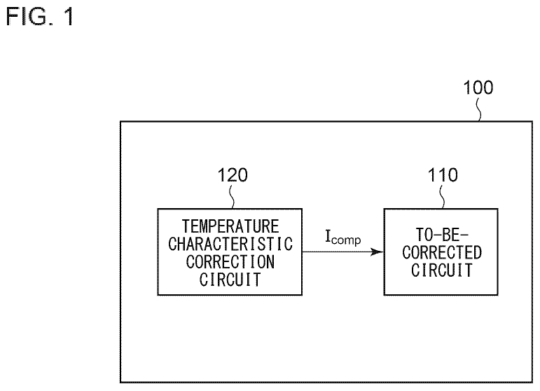

FIG. 1 is a block diagram of a semiconductor integrated circuit 100 according to an embodiment. The semiconductor integrated circuit 100 includes a to-be-corrected circuit 110 that is a temperature characteristic compensation target and a temperature characteristic correction circuit 120. The temperature characteristic correction circuit 120 supplies a correction current Icomp having temperature dependency to the to-be-corrected circuit 110 and corrects temperature dependency of the to-be-corrected circuit 110. The to-be-corrected circuit 110 may be a constant voltage source or a constant current source, although not limited thereto.

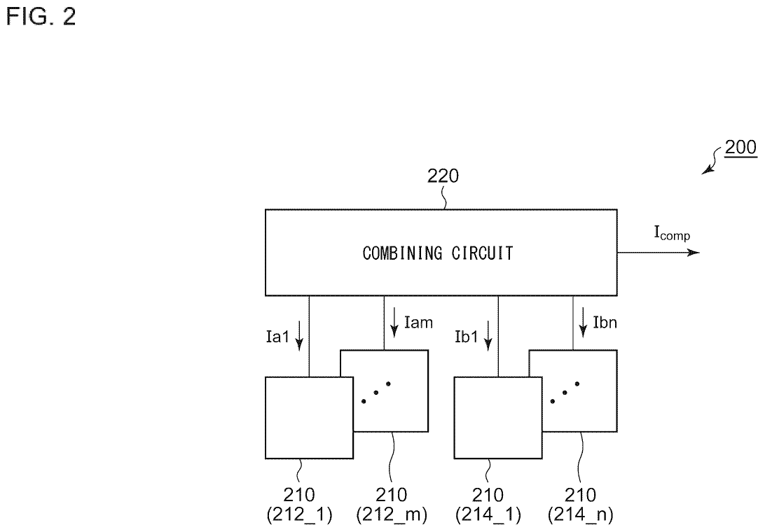

Hereinafter, a current generation circuit 200 that can be used as the temperature characteristic correction circuit 120 will be described. FIG. 2 is a block diagram of the current generation circuit 200. The current generation circuit 200 includes a plurality of current cells 210 and a combining circuit 220.

Each of the plurality of current cells 210 generates a temperature-dependent current. The temperature-dependent current generated by each of the current cells 210 is zero in a temperature range specific to the current cell, and linearly changes with respect to a temperature outside the temperature range.

There are two types of current cells 210: a low-temperature correction cell 212 and a high-temperature correction cell 214. The low-temperature correction cell 212 generates a low-temperature correction current Ia that is zero in a temperature range above its intrinsic threshold Ta and has a negative temperature coefficient α in a temperature range below the threshold Ta.

$$Ia = 0 ( Ta < T )$$

$$Ia = α \cdot ( T - Ta ) ( T < T a )$$

The high-temperature correction cell 214 generates a high-temperature correction current Ib that is zero in a temperature range below its intrinsic threshold Tb and has a positive temperature coefficient β in a temperature range above the threshold Tb.

$$Ib = 0 ( T < Tb )$$

$$Ib = β \cdot ( T - Tb ) ( Tb < T )$$

The plurality of current cells 210 include at least one (m) low-temperature correction cells 212_1 to 212_m and/or at least one (n) high-temperature correction cells 214_1 to 214-n.

The current cells 210 may include only the plurality of low-temperature correction cells 212. The current cells 210 may include only the plurality of high-temperature correction cells 214. The current cells 210 may include both one or more low-temperature correction cells 212 and one or more high-temperature correction cells 214.

The combining circuit 220 combines the plurality of temperature-dependent currents Ia and Ib generated by the plurality of current cells 210 to generate a correction current Icomp. When a low-temperature correction current generated by an i-th (1≤i≤m) low-temperature correction cell 212_i is denoted by Iaᵢ, and a high-temperature correction current generated by a j-th (1≤j≤n) high-temperature correction cell 214_j is denoted by Ibⱼ, the correction current Icomp is expressed by formula (1). Caᵢ and Cbⱼ are combining coefficients.

$$Icomp = {\sum }_{i = 1 : m} {Ca}_{i} I {a}_{i} + {\sum }_{j = 1 : n} {Cb}_{i} {Ib}_{j} \qquad ( 1 )$$

The above is the configuration of the current generation circuit 200.

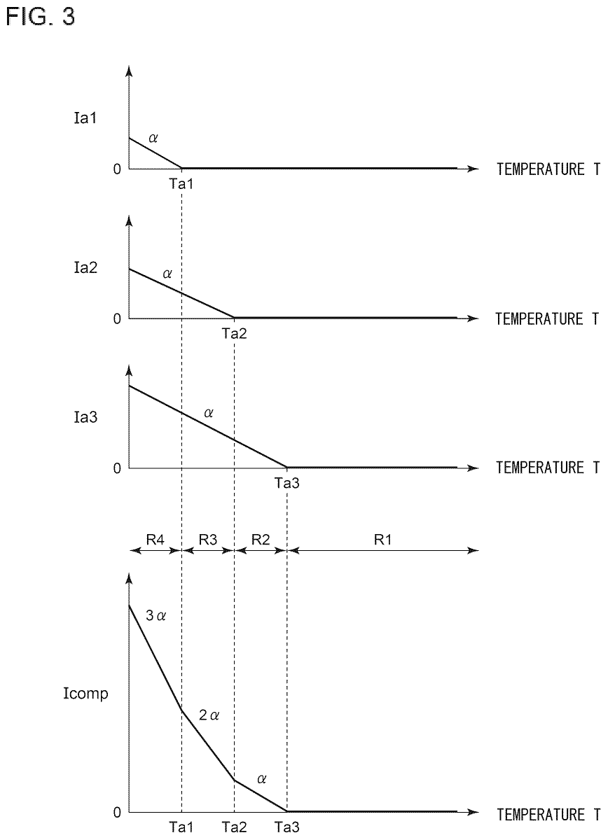

FIG. 3 is a diagram for describing an example of an operation of the current generation circuit 200. Here, m=3, n=0, and Ca₁=Ca₂=Ca₃=1.

The correction current Icomp is zero in a temperature range R1 of Ta3<T, has a negative temperature coefficient a in a temperature range R2 of Ta2<T<Ta3, has a negative temperature coefficient of 2 α in a temperature range R3 of Ta1<T<Ta2, and has a negative temperature coefficient of 3 α in a temperature range R4 of T<Ta1.

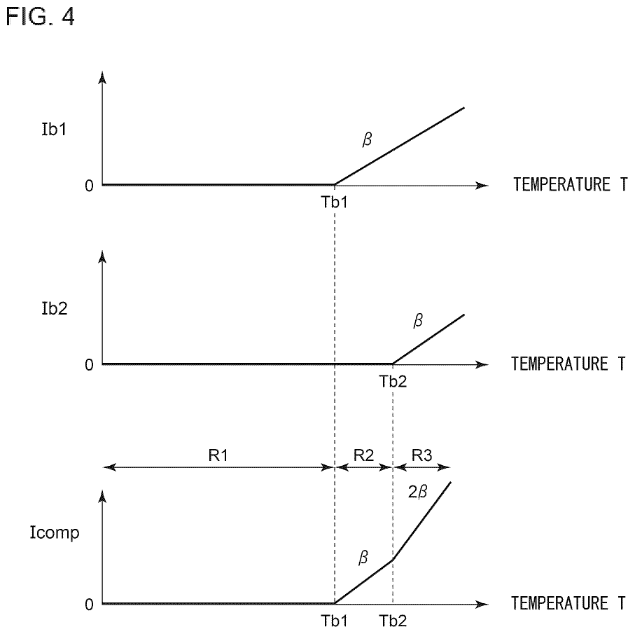

FIG. 4 is a diagram for describing another example of the operation of the current generation circuit 200. Here, m=0, n=2, and Cb₁=Cb₂=1.

The correction current Icomp is zero in a temperature range R1 of T<Tb1, has a positive temperature coefficient β in a temperature range R2 of Tb1<T<Tb2, and has a positive temperature coefficient of 2 β in a temperature range R3 of Tb2<T.

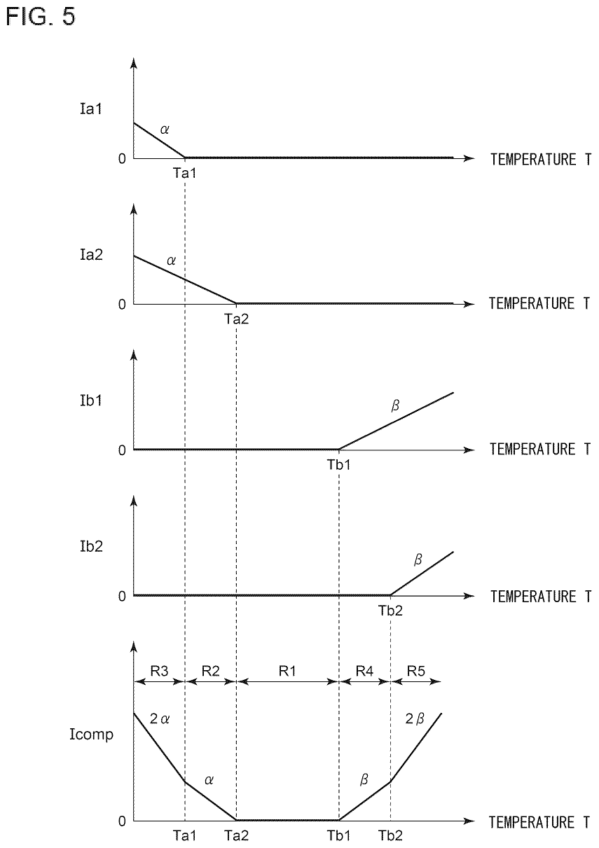

FIG. 5 is a diagram for describing an example of the operation of the current generation circuit 200. Here, m=2, n=2, and Ca₁=Ca₂=Cb₁=Cb₂=1.

The correction current Icomp is zero in a temperature range R1 of Ta2<T<Tb1, has a negative temperature coefficient a in a temperature range R2 of Ta2<T<Ta2, and has a negative temperature coefficient of 2 α in a temperature range R3 of T<Ta2. In addition, the correction current Icomp has a positive temperature coefficient β in a temperature range R4 of Tb1<T<Tb2, and has a positive temperature coefficient of 2 β in a temperature range R5 of Tb2<T.

The above is the operation of the current generation circuit 200. According to this current generation circuit 200, the correction current Icomp having various temperature characteristics can be generated according to the number of current cells 210, a combination of types of the current cells 210, and a combination of the coefficients Ca and Cb of the combining circuit 220. The temperature dependency of the correction current Icomp only needs to be designed in consideration of a temperature characteristic of the to-be-corrected circuit 110.

Next, a configuration example of the current cell 210 will be described.

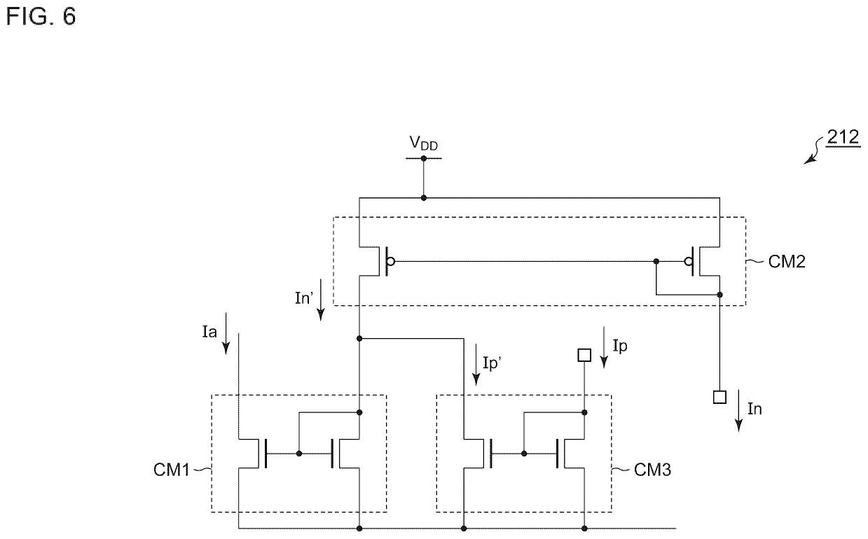

FIG. 6 is a circuit diagram illustrating a configuration example of the low-temperature correction cell 212. The low-temperature correction cell 212 includes the first current mirror circuit CM1 to the third current mirror circuit CM3.

A current Ip having a positive temperature coefficient and a current In having a negative temperature coefficient are supplied to the low-temperature correction cell 212. The current Ip having a positive temperature coefficient may be a proportional to absolute temperature (PTAT) current proportional to an absolute temperature. The current In having a negative temperature coefficient may be a complementary to absolute temperature (CTAT) current complementary to the PTAT current.

The low-temperature correction cell 212 is configured to generate the low-temperature correction current Ia by subtracting a current Ip′ having a positive temperature coefficient from a current In′ having a negative temperature coefficient.

The second current mirror circuit CM2 folds the current In having a negative temperature coefficient, and supplies a folded current In′ to an input of the first current mirror circuit CM1. The third current mirror circuit CM3 folds the current Ip having a positive temperature coefficient and draws a folded current Ip′ from the input of the first current mirror circuit CM1 to another path.

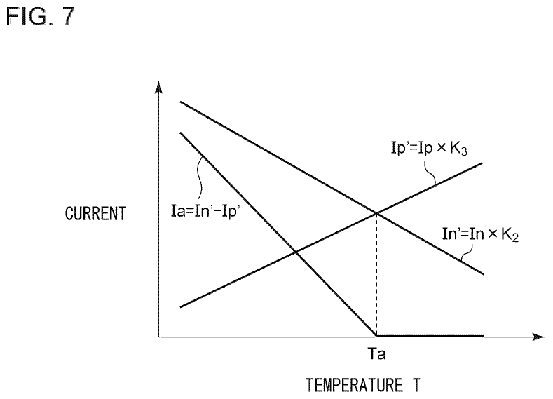

FIG. 7 is a diagram for describing an operation of the low-temperature correction cell 212 of FIG. 6. An output current of the second current mirror circuit CM2 is In′=In×K₂, and an output current of the third current mirror circuit CM3 is Ip′=Ip×K₃. K₂ and K₃ are mirror ratios of the second current mirror circuit CM2 and the third current mirror circuit CM3, respectively. A threshold temperature Ta is determined by a temperature at which the output current In′ of the second current mirror circuit CM2 and the output current Ip′ of the third current mirror circuit CM3 are equal to each other.

At T>Ta, In′<Ip′ is satisfied, and therefore the low-temperature correction current Ia that is an output current of the first current mirror circuit CM1 is zero. At T<Ta, the low-temperature correction current Ia is In′−Ip′=In×K₂−Ip×K₁.

The threshold temperature Ta can be adjusted according to the respective mirror ratios K₂ and K₃ of the two current mirror circuits CM2 and CM3.

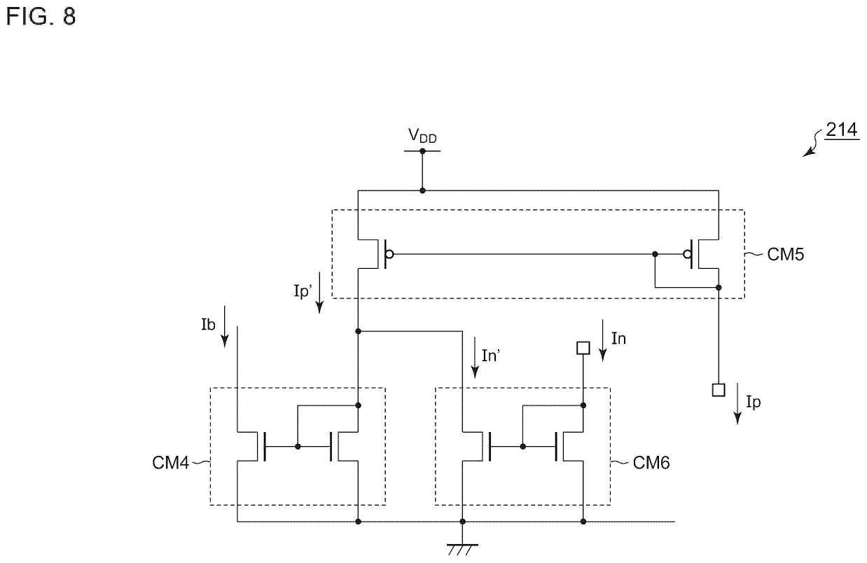

FIG. 8 is a circuit diagram illustrating a configuration example of the high-temperature correction cell 214. The high-temperature correction cell 214 includes the fourth current mirror circuit CM4 to the sixth current mirror circuit CM6.

A current Ip having a positive temperature coefficient and a current In having a negative temperature coefficient are supplied to the high-temperature correction cell 214.

The high-temperature correction cell 214 is configured to generate the high-temperature correction current Ib by subtracting a current In′ having a positive/negative temperature coefficient from a current Ip′ having a positive temperature coefficient.

The fifth current mirror circuit CM5 folds the current Ip having a positive temperature coefficient and supplies a folded current Ip′ to an input of the fourth current mirror circuit CM4. The sixth current mirror circuit CM6 folds the current In having a negative temperature coefficient, and draws a folded current In′ from the input of the fourth current mirror circuit CM4 to another path.

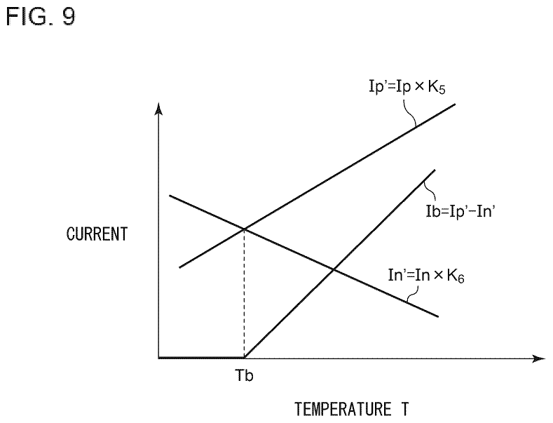

FIG. 9 is a diagram for describing an operation of the high-temperature correction cell 214 of FIG. 8. An output current of the fifth current mirror circuit CM5 is Ip′=Ip×K₅, and an output current of the sixth current mirror circuit CM6 is In′=In′×K₆. K₅ and K₆ are mirror ratios of the fifth current mirror circuit CM5 and the sixth current mirror circuit CM6, respectively. A threshold temperature Tb is determined by a temperature at which the output current Ip′ of the fifth current mirror circuit CM5 and the output current In′ of the sixth current mirror circuit CM6 are equal to each other.

At T<Tb, In′>Ip′ is satisfied, and therefore the high-temperature correction current Ib that is an output current of the fourth current mirror circuit CM4 is zero. At Tb<T, the high-temperature correction current Ib is Ip′−In′=Ip×K₅−In×K₆.

The threshold temperature Tb can be adjusted according to the respective mirror ratios K₅ and K₆ of the two current mirror circuits CM5 and CM6.

The current generation circuit 200 may be individually designed according to the to-be-corrected circuit 110 that is a compensation target. Alternatively, the current generation circuit 200 may be designed with versatility capable of corresponding to various to-be-corrected circuits 110. In this case, the combining circuit 220 may be configured such that the coefficients Ca₁ to Caₘ and the coefficients Cb₁ to Cbₙ are variable.

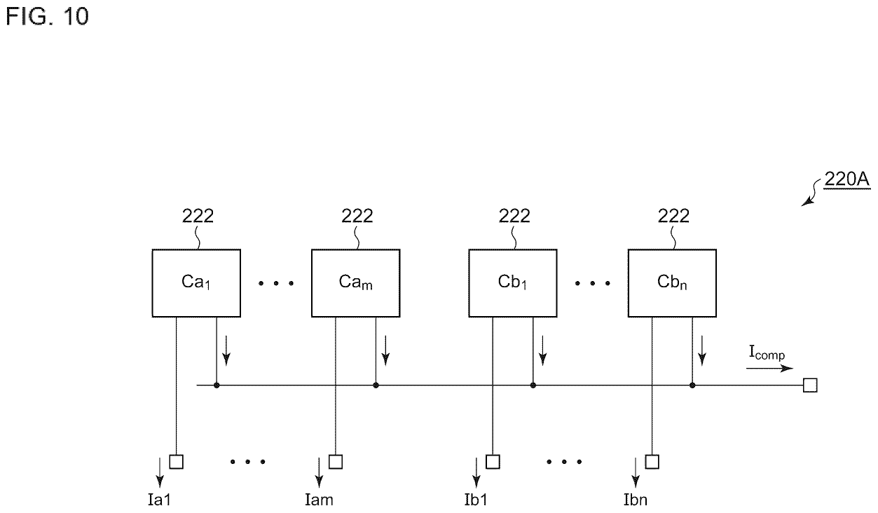

FIG. 10 is a circuit diagram of a combining circuit 220A according to one example. The combining circuit 220A includes a plurality of current mirror circuits 222 corresponding to the plurality of current cells 210. Each of the plurality of current mirror circuits 222 can switch a mirror ratio. The mirror ratio of each of the current mirror circuits 222 corresponds to a coefficient Ca or Cb. The combining circuit 220A outputs a total current of output currents of the plurality of current mirror circuits 222 as a correction current Icomp. The combining circuit 220A of FIG. 10 can generate a positive correction current Icomp.

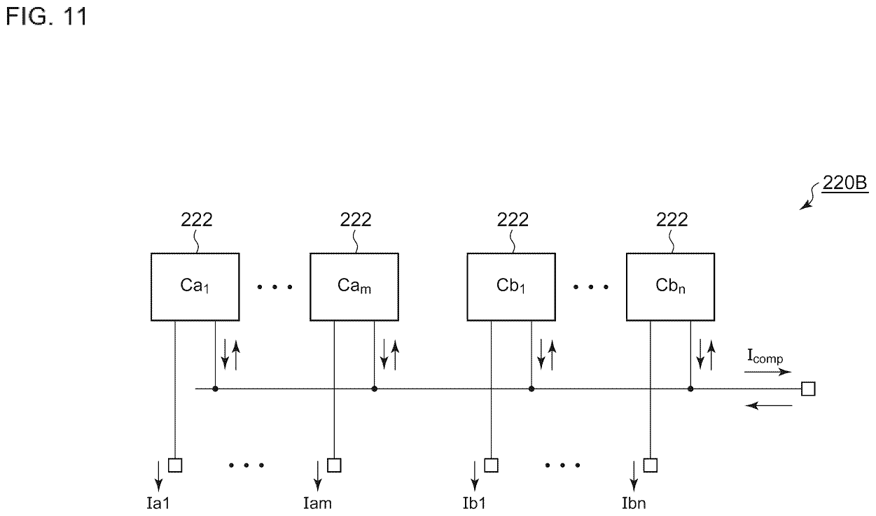

FIG. 11 is a circuit diagram of a combining circuit 220B according to one example. The combining circuit 220 includes a plurality of current mirror circuits 222 corresponding to the plurality of current cells 210. Similarly to FIG. 10, each of the current mirror circuits 222 can switch a mirror ratio. Furthermore, in FIG. 11, each of the current mirror circuits 222 can switch a direction of an output current (polarity, that is, source/sink). When the polarity of the current mirror circuit 222 is positive (source), a coefficient thereof Ca/Cb can be positive, and when the polarity of the current mirror circuit 222 is negative (sink), the coefficient Ca/Cb can be negative.

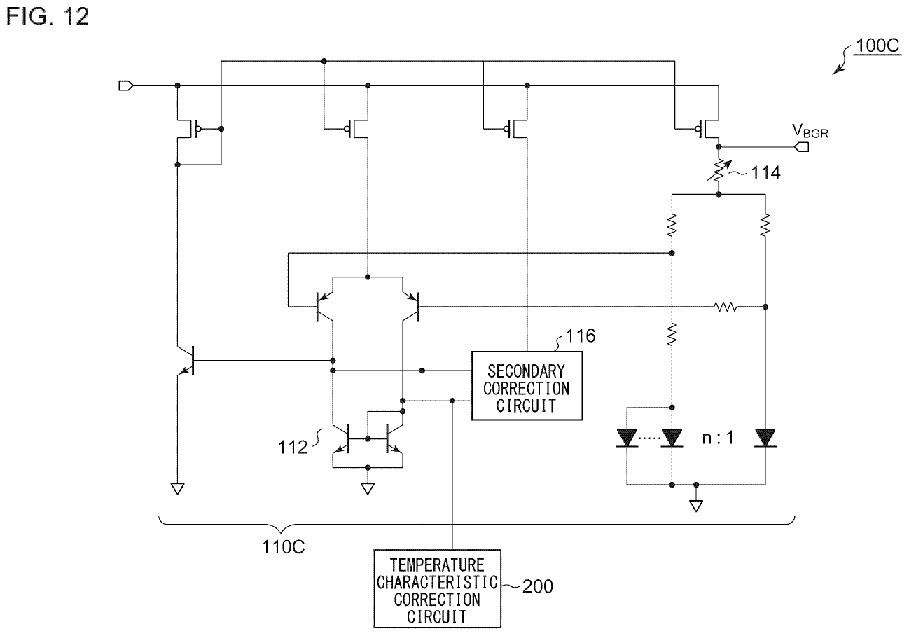

FIG. 12 is a circuit diagram illustrating a semiconductor integrated circuit 100C according to one example. The semiconductor integrated circuit 100C includes a bandgap reference circuit 110C that is a to-be-corrected circuit. The bandgap reference circuit 110C includes a primary correction circuit 114 and a secondary correction circuit 116. The primary correction circuit 114 includes a resistor and corrects a primary temperature characteristic. The secondary correction circuit 116 is coupled to a collector of a differential pair of an amplifier 112 and corrects a secondary temperature characteristic.

The current generation circuit 200 is coupled to the collector of the differential pair of the amplifier 112 and corrects temperature dependency that cannot be compensated by the primary correction circuit 114 and the secondary correction circuit 116.

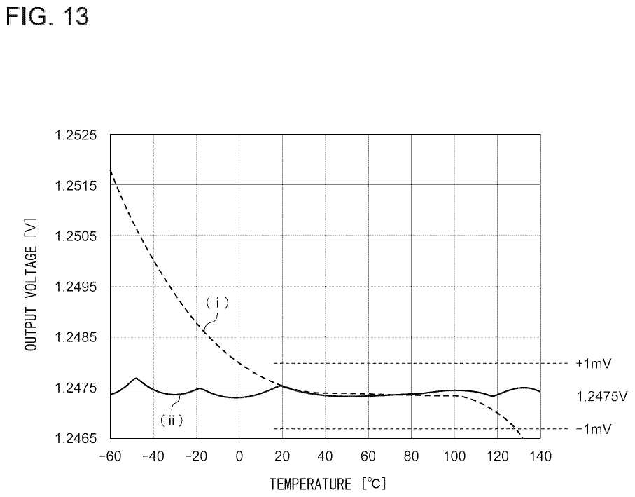

FIG. 13 is a diagram illustrating a temperature characteristic of an output voltage V_{BGR} of the bandgap reference circuit 110C of FIG. 12. A broken line (i) indicates a temperature characteristic when the current generation circuit 200 is not disposed, in which temperature dependency higher than a third order remains. A solid line (ii) indicates a temperature characteristic in a case where the current generation circuit 200 is added. The current generation circuit 200 can correct temperature dependency of each of the high temperature region and the low temperature region, and can stabilize a voltage V_{BGR} in a range of ±1 mV in a wide range of −60° C. to 140° C.

### Modification

The above-described embodiments are described for illustrative purposes, and it is understood by those skilled in the art that various modifications can be made to combinations of the components and the processing processes of the embodiments. Hereinafter, such a modification will be described.

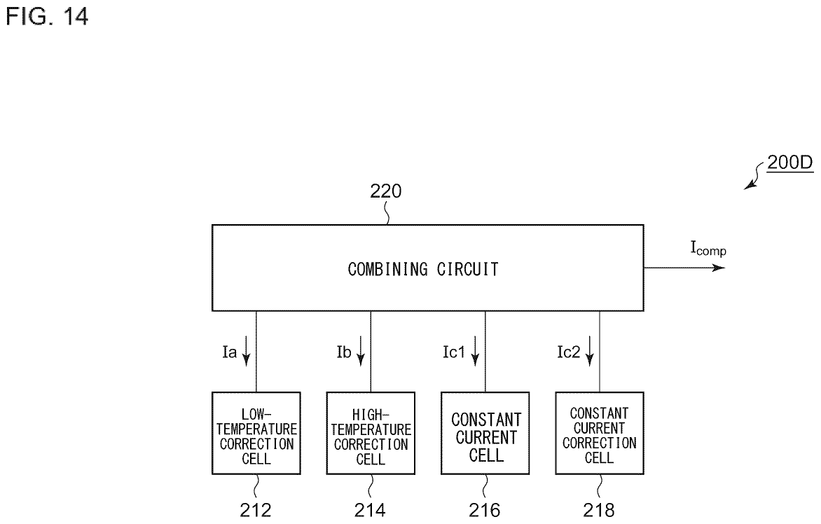

FIG. 14 is a circuit diagram of a current generation circuit 200D according to Modification 1. The current generation circuit 200D includes a low-temperature correction cell 212, a high-temperature correction cell 214, constant current cells 216 and 218, and a combining circuit 220.

The low-temperature correction cell 212 generates a low-temperature correction current Ia. The high-temperature correction cell 214 generates a high-temperature correction current Ib. The constant current cells 216 and 218 generate constant currents Ic1 and Ic2 having different current amounts and having no temperature dependency, respectively.

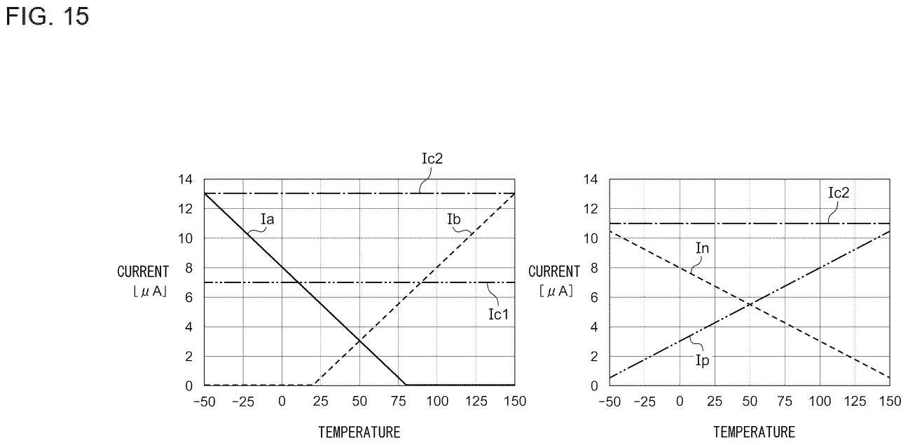

FIG. 15 is a diagram for describing an operation of the current generation circuit 200D of FIG. 14. The left diagram of FIG. 15 illustrates the currents Ia, Ib, Ic1, and Ic2. A threshold Ta of the low-temperature correction cell 212 is 80° C., a threshold Tb of the high-temperature correction cell 214 is 20° C., the constant current Ic1=7 μA, and Ic2=11 μA.

The right diagram of FIG. 15 illustrates a method for generating the current Ic2. The constant current cell 218 receives a current Ip having a positive temperature coefficient and a current In having a negative temperature coefficient, add the current Ip and the current In, and can thereby generate the constant current Ic2.

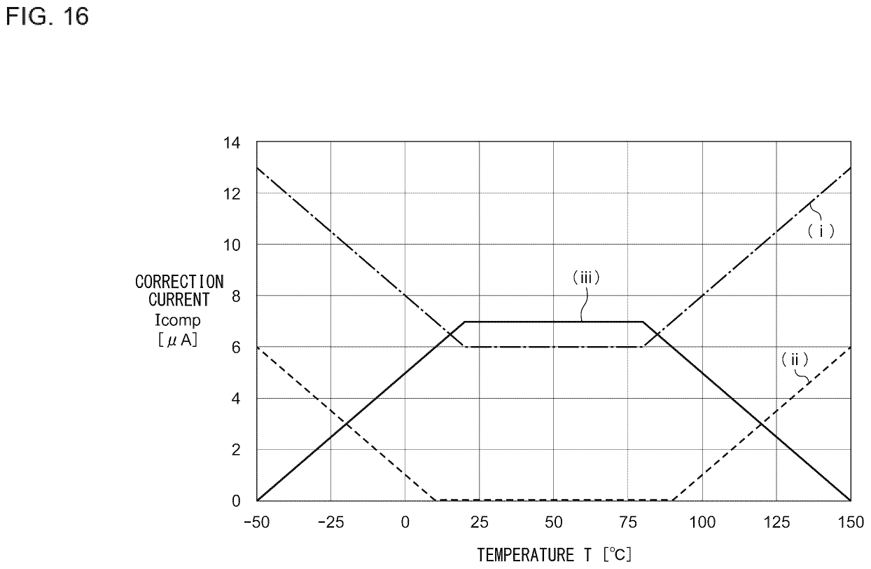

FIG. 16 is a diagram for describing a setting example of the combining circuit 220 in the current generation circuit 200D of FIG. 14. (i) is an example in which Icomp=Ia+Ib is satisfied. (ii) is an example in which Icomp=Ia+Ib−Ic1 is satisfied. (iii) is an example in which Icomp=Ic2−(Ia+Ib) is satisfied.

The embodiments are described for illustrative purposes, and it is understood by those skilled in the art that various modifications can be made to combinations of the components and the processing processes of the embodiments and that such modifications are also within the scope of the present disclosure or the present invention.

### Appendix

The following techniques are disclosed in the present specification.

Item 1

A current generation circuit including:
a plurality of current cells, wherein each of the plurality of current cells is structured to generate a temperature-dependent current, the temperature-dependent current is zero in a temperature range intrinsic to the current cell, and linearly changes with respect to a temperature outside the temperature range; and
a combining circuit that combines the plurality of temperature-dependent currents generated by the plurality of current cells.

Item 2

The current generation circuit according to item 1,
in which the plurality of current cells include at least one low-temperature correction cell, and
the low-temperature correction cell generates a low-temperature correction current that is zero in a temperature range above a threshold intrinsic thereto and has a negative temperature coefficient in a temperature range below the threshold.

Item 3

The current generation circuit according to item 2, in which the low-temperature correction cell generates the low-temperature correction current by subtracting a current having a positive temperature coefficient from a current having a negative temperature coefficient.

Item 4

The current generation circuit according to item 3,
in which the low-temperature correction cell includes:
a first current mirror circuit;
a second current mirror circuit that folds the current having a negative temperature coefficient and supplies the current to an input of the first current mirror circuit; and
a third current mirror circuit that folds the current having a positive temperature coefficient and draws the current from the input of the first current mirror circuit to another path.

Item 5

The current generation circuit according to any one of items 1 to 4,
in which the plurality of current cells include at least one high-temperature correction cell, and
the high-temperature correction cell generates a high-temperature correction current that is zero in a temperature range below a threshold intrinsic thereto and has a positive temperature coefficient in a temperature range above the threshold.

Item 6

The current generation circuit according to item 5, in which the high-temperature correction cell generates the high-temperature correction current by subtracting a current having a negative temperature coefficient from a current having a positive temperature coefficient.

Item 7

The current generation circuit according to item 6,
in which the high-temperature correction cell includes:
a fourth current mirror circuit;
a fifth current mirror circuit that folds the current having a positive temperature coefficient and supplies the current to an input of the fourth current mirror circuit; and a sixth current mirror circuit that folds the current having a negative temperature coefficient and draws the current from the input of the fourth current mirror circuit to another path.

Item 8

The current generation circuit according to any one of items 1 to 7, in which the combining circuit has a variable ratio among the plurality of currents.

Item 9

The current generation circuit according to any one of items 1 to 8, further including
a constant current cell that generates a constant current not dependent on temperature,
in which the combining circuit combines the plurality of temperature-dependent currents and the constant current.

Item 10

The current generation circuit according to item 9, in which the constant current cell generates the constant current by adding a current having a positive temperature coefficient and a current having a negative temperature coefficient.

Item 11

The current generation circuit according to any one of items 1 to 10, which is integrally integrated on one semiconductor substrate.

Item 12

A semiconductor integrated circuit including:
a bandgap reference circuit; and
the current generation circuit according to any one of items 1 to 10, to be coupled to the bandgap reference circuit.

What is claimed is:

1. A current generation circuit comprising:
a plurality of current cells, wherein each of the current cells is structured to generate a temperature-dependent current, the temperature-dependent current is zero in a temperature range intrinsic to the current cell, and linearly changes with respect to a temperature outside the temperature range; and
a combining circuit structured to combine the plurality of temperature-dependent currents generated by the plurality of current cells.

2. The current generation circuit according to claim 1,
wherein the plurality of current cells includes at least one low-temperature correction cell, and
the low-temperature correction cell generates a low-temperature correction current that is zero in a temperature range above a threshold intrinsic thereto and has a negative temperature coefficient in a temperature range below the threshold.

3. The current generation circuit according to claim 2, wherein the low-temperature correction cell generates the low-temperature correction current by subtracting a current having a positive temperature coefficient from a current having a negative temperature coefficient.

4. The current generation circuit according to claim 3,
wherein the low-temperature correction cell includes:
a first current mirror circuit;
a second current mirror circuit structured to fold the current having a negative temperature coefficient and to supply the current to an input of the first current mirror circuit; and
a third current mirror circuit structured to fold the current having a positive temperature coefficient and to draw the current from the input of the first current mirror circuit to another path.

5. The current generation circuit according to claim 1,
wherein the plurality of current cells include at least one high-temperature correction cell, and
the high-temperature correction cell generates a high-temperature correction current that is zero in a temperature range below a threshold intrinsic thereto and has a positive temperature coefficient in a temperature range above the threshold.

6. The current generation circuit according to claim 5, wherein the high-temperature correction cell generates the high-temperature correction current by subtracting a current having a negative temperature coefficient from a current having a positive temperature coefficient.

7. The current generation circuit according to claim 6,
wherein the high-temperature correction cell includes:
a fourth current mirror circuit;
a fifth current mirror circuit structured to fold the current having a positive temperature coefficient and to supply the current to an input of the fourth current mirror circuit; and
a sixth current mirror circuit structured to fold the current having a negative temperature coefficient and to draw the current from the input of the fourth current mirror circuit to another path.

8. The current generation circuit according to claim 1, wherein the combining circuit has a variable ratio among the plurality of currents.

9. The current generation circuit according to claim 1, further comprising
a constant current cell structured to generate a constant current not dependent on temperature,
wherein the combining circuit combines the plurality of temperature-dependent currents and the constant current.

10. The current generation circuit according to claim 9, wherein the constant current cell generates the constant current by adding a current having a positive temperature coefficient and a current having a negative temperature coefficient.

11. The current generation circuit according to claim 1, which is integrally integrated on one semiconductor substrate.

12. A semiconductor integrated circuit comprising:
a bandgap reference circuit; and
the current generation circuit according to claim 1, to be coupled to the bandgap reference circuit.
